(19) United States
(12) Patent Application Publication
(10) Pub. No.: US 2026/0141431 A1
(43) Pub. Date: May 21, 2026

(54) TouchDate Technique

(71) Applicant: Jennifer Syquia Skarne, Manchester-by-the-Sea, MA (US)

(72) Inventor: Jennifer Syquia Skarne, Manchester-by-the-Sea, MA (US)

(21) Appl. No.: 18/948,578

(22) Filed: Nov. 15, 2024

(51) Int. Cl. G06Q 30/0601; A44C 27/00

(52) U.S. Cl. CPC G06Q 30/0621; A44C 27/00

(57) ABSTRACT

The TouchDate technique is an innovative approach to personalized jewelry design, integrating both tactile and non-tactile elements to encode significant dates in a way that creates a private and meaningful connection for the wearer. Unlike traditional commemorative jewelry, which often uses visible markers like engravings, birthstones, or other decorative features, TouchDate takes a more discreet and personalized approach by arranging elements—either raised or flat—according to a specific system that corresponds to a chosen date, such as an anniversary or birthday. Tactile components, like raised metal domed dots or diamonds, are carefully placed to represent the month and day of the significant date, allowing the wearer to physically feel the representation of their memory. This tactile interaction creates a sensory connection, offering a subtle yet constant reminder of the personal milestone.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to the field of personalized jewelry, specifically using tactile elements, such as diamonds or raised metal dots, to represent significant dates. It transforms dates into tactile, sensory features, enabling a physical connection between the wearer and their memory. This method is adaptable to various types of jewelry and offers discrete, personalized meaning through physical touch rather than visual cues.

### Description of the Related Art

Jewelry has long been a form of personal expression and a means to commemorate important life events, such as anniversaries, birthdays, and other milestones. While many people choose jewelry adorned with engravings, birthstones, or symbolic designs, these approaches often remain purely visual. The TouchDate Technique introduces an additional sensory dimension by allowing the wearer to physically feel the significance of a given date. This tactile interaction enhances the emotional connection between the wearer and the jewelry, making it more meaningful. Such a personalized, sensory-focused design elevates the jewelry-wearing experience to a more intimate and emotional level, differentiating it from traditional approaches.

The global jewelry market was valued at over $270 billion in 2023, with the personalized jewelry segment experiencing rapid growth. This segment, worth approximately $40 billion, continues to expand as consumers increasingly seek unique, customized products. Furthermore, studies have shown that over 70% of consumers are drawn to jewelry with personal or sentimental value, making custom designs and personalization one of the most sought-after trends. Additionally, wearable technology and sensory engagement, where tactile feedback is becoming increasingly important, are growing rapidly across various markets, including jewelry. Consumers seek deeper connections with the products they wear, which explains the surging demand for innovative and emotionally resonant designs.

Several innovations in the personalized jewelry space have already made strides in offering unique designs. Engraved jewelry allows individuals to inscribe dates, names, or messages on their rings, pendants, or bracelets. Birthstone jewelry enables customers to incorporate specific gemstones representing their birth month or the birth dates of loved ones. Another recent innovation is smart jewelry, which integrates technology to provide notifications or health tracking while maintaining an elegant design. However, despite these advances, most innovations remain focused on visual elements—text, color, or gemstone choices—without incorporating other senses, such as touch, in a meaningful way.

In recent years, there has been a growing trend toward sensory engagement in consumer products, particularly those that cater to emotional and experiential needs. Consumers increasingly seek items that not only serve a practical or aesthetic purpose but also engage their senses, providing a deeper connection to their personal experiences. Products such as wearable technology, smart jewelry, and interactive devices have gained popularity for their ability to create emotional bonds through touch, sound, or even movement. This shift reflects the consumer's desire for more meaningful and personalized connections with their possessions, particularly those that commemorate special moments or relationships.

By looking at prior art, multiple innovations can be seen. For instance, a US patent 2,023,0284755A1 relates to method of transposing dates into times for commemorative customized jewelry designs. The present invention provides a method of commemorating at least one special date for an individual with a customized jewelry design. The method comprises selecting at least one day, from numbers 1 through 31, and at least one month, from numbers 1 through 12, that the individual wishes to commemorate; placing at least one first design element which corresponds to the at least one selected day on a base element, said base element divided into sixty visible or invisible segments to represent a clock face with a top point on the clock face representing noon or midnight and referred to as a zero point, wherein the placement of the at least one first design element represents at least one minute hand of the clock and placing at least one second design element which corresponds to the at least one selected month on the base element, wherein the placement of the at least one second design element represents at least one hour hand of the clock. The customized jewelry may include, without limitation, pendants, earrings, bracelets or rings.

A U.S. Pat. No. 5,081,852A relates to a Display bracelet. The article of jewelry, namely a bracelet having a band containing plurality of individualized transparent compartments with removable transparent windows for displaying on the wrist numerous pictures, photographs, or other decorative or useful items. Further, the windows of the compartments are easily interchangeable and may be transparent, flat, convex for magnification, or some other suitable design. The invention constitutes a multipurpose and easily customized bracelet. Also, the inner wall of the band is transparent to permit display of photographs or pictures back-to-back on both sides of the bracelet.

A KR patent 2,004,79784Y1Ring for displaying a memorial day The present invention relates to a ring in which anniversaries are displayed, and the technical point relates to a ring in which a user's birthday or a month and day of a desired anniversary are displayed so that the user can remind the anniversary. More specifically, on the upper surface of the body of the ring made of different materials so as to realize the individual concept of the upper part and the lower part, a letter part is displayed in alphabetical letters from January to December, To 31 days are formed by Arabic numerals, so that the letters and numbers corresponding to the month and day of the anniversary that the user specifically wants to display are deleted, and a diamond, The present invention relates to a ring in which anniversary dates are displayed so that the user can remind the anniversaries indicated by wearing the rings, as well as a sense of beauty by providing decorative jewelry such as a birthstone.

A CN patent 1,173,55238A relates to custom jewelry design by transposing dates to times. The present invention provides a custom jewelry design for pendants, earring, bracelets, rings, and other types of jewelry that displays a specific time or a specific calendar date on the jewelry to commemorate a specific event or a specific date. The jewelry is divided into sixty sections and at least one set comprising two design elements is placed on the jewelry. The first element in the set is positioned at one of the sixty sections on the jewelry, representing the hour hand of the clock. The second design in the set is also positioned at one of the sixty sections on the jewelry, representing a minute hand. The placement of each set of design elements may represent a particular time, or the particular time may represent a calendar date (i.e., the number of months and the number of days) that has been transposed to one or more particular times on a clock.

The cited US Patent 2,023,0284755A1 transposes dates into clock positions, allowing for a creative way to commemorate special occasions by marking hours and minutes on jewelry. While this offers a novel method of visualizing dates, the design remains mechanical and lacks the emotional depth that could create a more personal connection. It focuses purely on the aesthetic representation of time, rather than on fostering an emotional or interactive experience for the user.

TouchDate surpasses this by introducing a tactile and emotional dimension that goes beyond static representation. Each touch on the jewelry triggers a personalized connection, making it an intimate experience. Instead of just seeing dates transposed into time, users engage with their memories in a way that evokes emotional responses. This tactile interaction creates a richer, more meaningful connection, which cannot be achieved by merely translating dates into mechanical clock components.

Similarly, U.S. Pat. No. 5,081,852A's display bracelet allows users to customize with photos or decorative elements in transparent compartments. While it provides a visual reminder of personal moments, it lacks any deeper interaction or emotional engagement. The customization is limited to static, interchangeable visuals, making it more about the appearance than fostering a deeper connection to memories.

TouchDate introduces emotional interactivity through touch, allowing users to not only see but feel their memories. This tactile personalization goes beyond what the display bracelet or KR Patent 2,004,79784Y1's date-display ring can offer. Both of these inventions rely on visual reminders, whether through transparent windows or numerical representations of dates. In contrast, TouchDate offers an intimate, sensory connection that enhances emotional engagement, making the jewelry a living, discreet, and deeply personal commemorative object. This is where TouchDate stands superior: by embedding emotional depth and interaction into the jewelry experience, it provides a unique dimension that static visual designs simply cannot replicate.

Despite the progress in personalized jewelry, several gaps remain. Engravings, while a common choice, are primarily visual and lose their impact when out of sight, making them less engaging. Birthstones, while representative of a birth month, do not offer precise personalization when it comes to specific dates or meaningful moments. Furthermore, these traditional approaches are widely recognizable, reducing the sense of privacy and discretion for those seeking a more subtle connection to their memories. Many people also desire a sensory connection to their personal milestones, one that goes beyond visual aesthetics. The market still lacks options for jewelry that combines personal significance with tactile engagement, giving the wearer the ability to physically interact with their meaningful dates.

The TouchDate Technique fills this gap by introducing a tactile, personalized jewelry system where specific dates can be encoded and represented through a series of raised elements, such as diamonds or metal dots. Each element corresponds to a number that signifies the month and day of a special date, creating a unique and subtle representation of that milestone. Unlike engravings or birthstones, the date is not immediately apparent to others, ensuring the personalization remains private and meaningful only to the wearer. This technique can be applied to a variety of jewelry types—rings, pendants, earrings, and bracelets—offering both versatility and emotional resonance. By physically feeling the raised elements on their jewelry, the wearer creates a sensory memory connection that transforms the jewelry into a truly interactive piece of personal significance.

The TouchDate Technique incorporates both tactile and non-tactile elements to create jewelry that encodes significant dates in ways that maintain a deep, personal connection for the wearer. While tactile features are a primary focus, non-tactile elements—such as flat, recessed, or visually oriented designs—play an equally important role in achieving a discreet, personalized experience. These non-tactile elements can include geometric patterns, color-coded sections, or other visual cues that systematically encode dates like anniversaries or birthdays. Although these elements lack physical texture, they are designed to be subtle, private, and meaningful, allowing only the wearer to recognize the encoded date. This thoughtful approach enhances the wearer's connection to the memory, adding a personal dimension that goes beyond surface decoration.

The Technique fills a unique gap in the jewelry market by offering a form of personalization that extends beyond traditional visual elements like engravings or birthstones. Traditional methods, while popular, often lack the sensory engagement and privacy that modern consumers seek. By integrating tactile elements like diamonds or raised dots that subtly encode the chosen date, the TouchDate Technique offers a private, touch-based way for wearers to connect with their memories. This hidden encoding system allows wearers to cherish important dates discreetly, tapping into the growing demand for unique, meaningful jewelry that goes beyond mere visual aesthetics.

This innovative approach promises to carve out a distinct niche in the personalized jewelry market, appealing to consumers who value intimate, sensory-rich connections with their jewelry. In creating pieces that serve as constant, discreet reminders of significant life moments, the TouchDate Technique combines emotional depth with sensory engagement, turning jewelry into an experience that resonates on multiple levels.

The TouchDate Technique offers a uniquely interactive experience for the wearer, blending tactile engagement with raised elements and visual recognition of non-tactile designs. Each interaction—whether through the touch of raised components or the visual acknowledgment of encoded dates—strengthens the emotional connection between the wearer and their jewelry. This thoughtful design transforms the piece into a constant reminder of a cherished memory, making it not only an accessory but also a deeply personal and meaningful keepsake.

Unlike braille jewelry, which is designed to convey functional text through raised dots for reading letters and words, TouchDate centers around the representation of emotional memories rather than textual communication. Instead of letters, significant dates are transformed into tactile symbols—such as diamonds or subtly raised metal dots—that the wearer can feel. The focus is on creating a sensory experience that evokes a special moment rather than delivering readable information. This design allows the wearer to feel a meaningful connection with their memories, making the experience about cherishing important dates rather than decoding text.

Jewelry that provides tactile engagement, like TouchDate, fulfills emotional needs by allowing users to interact with significant memories through touch physically. Traditional jewelry may serve as a visual reminder, but adding a layer of sensory experience enhances the emotional impact, making the connection more personal and intimate. By tapping into the trend of sensory engagement, TouchDate meets the market demand for emotionally fulfilling products, offering a decorative item and an interactive, meaningful connection to important life moments. This tactile interaction satisfies the consumer's deeper emotional need for a tangible and private way to relive memories, making it highly relevant and desirable in today's market.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The present invention seeks to improve prior techniques and provide an advanced methodology for a tactile representation of important dates using diamonds or raised metal dots, allowing the wearer to physically connect with their milestones.

The invention offers a method of discrete personalization, where the significance of the date is hidden and only recognizable to the wearer or those familiar with the encoded milestone.

It is a further objective of the present invention to introduce an interactive and emotional experience through jewelry, allowing the wearer to engage with their memories by touching the tactile elements.

It is also an object of the invention to transform numbers, such as dates, into a physical, sensory representation, moving beyond traditional visual engravings or birthstones.

Further, the objective of the invention is to apply the TouchDate Technique across a variety of jewelry types, offering broad adaptability in rings, pendants, bracelets, earrings, and other wearable items.

It is also the objective of the invention to create a constant tactile reminder of significant dates, so that the wearer can recall their milestone by physically feeling the elements on the jewelry.

It is also the objective of the invention to offer a personalized jewelry customization method that combines emotional significance with tactile interaction, setting it apart from other aesthetic jewelry designs.

It is also the objective of the invention to enable a subtle yet meaningful design, where the encoded date is not immediately obvious to others but carries personal significance for the wearer.

It is further the objective of the invention to enhance the emotional engagement with jewelry by providing a sensory experience tied to personal memories, allowing wearers to “feel” their important life events.

It is the objective of the invention to offer a jewelry concept that is both functional and symbolic, combining aesthetic appeal with a practical method for representing significant dates in a tactile format.

It is also the objective of the invention to provide a unique way to symbolize dates without using visible engravings or traditional markers, offering an innovative and subtle alternative.

Thus, it is the objective to provide a new and improved allow for simple and versatile customization, where customers can easily choose a date and have it represented by tactile elements, ensuring personal meaning in each piece.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In recent years, there has been a growing demand for personalized and emotionally engaging jewelry that goes beyond traditional aesthetic value. Consumers are increasingly looking for pieces that hold deeper personal significance, whether through custom engravings, birthstones, or symbolic designs. This shift reflects a desire for jewelry that not only looks beautiful but also serves as a meaningful connection to personal memories and milestones. Alongside this trend, there has been a surge in interest in sensory and tactile products, evidenced by the popularity of fidget toys like the Fidget Spinner, which became widely loved for their interactive nature. This trend highlights the growing market for objects that people can physically engage with as a source of comfort or focus.

TouchDate responds directly to these evolving consumer preferences by offering a unique combination of personalization and sensory engagement. While most personalized jewelry relies on visible markers like engravings or birthstones, TouchDate introduces a tactile element that lets the wearer physically interact with their memories through raised diamonds or metal dots. This approach taps into the appeal of sensory objects, adding an emotional and tactile dimension that other forms of jewelry lack. By allowing the wearer to feel and engage with the jewelry in a more intimate way, TouchDate fulfills the demand for both personalized and emotionally immersive experiences, setting it apart in the competitive landscape of customized jewelry.

This invention relates to a distinctive and innovative method for transforming personal dates, such as birthdays, anniversaries, or other significant milestones, into a tactile and symbolic form. Unlike traditional jewelry that focuses primarily on aesthetic appeal or functional reading systems like Braille, the TouchDate Technique merges emotional significance with physical touch. It introduces an interactive element to the jewelry, offering the wearer an opportunity to connect with their memories through a unique sensory experience.

The invention as per its preferred embodiments focuses on the use of diamonds or raised metal “domed dots” as tactile elements to represent significant dates. Each element corresponds to a number in the date, with the month represented by one set of elements and the day by another. For instance, a date like March 5th would be represented by three diamonds (for the month of March) and five diamonds (for the 5th day), transforming these numbers into a physical, touchable form.

As per its further embodiments, unlike other forms of personalized jewelry, which may use engravings or visible birthstones to mark personal events, the TouchDate Technique transforms numbers into a sensory and physical representation. This method allows the act of wearing the jewelry to become an interactive and emotional experience, as the wearer can touch and feel the significance of the date encoded in their jewelry. It moves beyond visual representation, offering a deeper personal connection to the object.

As per its further embodiments, one of the key features of the TouchDate Technique is its discrete personalization. The number of tactile elements (diamonds or dots) is not immediately recognizable as a date to an external observer, allowing for a subtle, personal meaning that only the wearer or someone intimately familiar with the date would understand. The date remains hidden in plain sight, preserving the wearer's privacy while still offering a deep emotional connection to the jewelry.

As per its further embodiments, the TouchDate Technique creates a tactile reminder of the chosen date. Each time the wearer touches the raised elements on their jewelry, they are physically reminded of the special memory or milestone that the date represents. This transforms the piece from a mere visual object into a sensory experience, offering a unique emotional bond between the wearer and their jewelry. The constant sensory feedback deepens the wearer's connection to their cherished memory.

As per its further embodiments, the versatility of the proposed Technique allows it to be applied to a wide variety of jewelry types, including rings, necklaces, earrings, bracelets, pendants, and more. The tactile elements can be integrated into each of these forms, providing broad flexibility in its application. Whether spaced around the band of a ring or distributed along a bracelet, the tactile encoding can be customized based on the design of the jewelry and the wearer's preference.

As per its further embodiments, The proposed Technique involves several key steps in its creation. First, the customer selects a specific jewelry piece, such as a ring, pendant, or earrings, as the canvas for their personalized date encoding. The jewelry is then crafted from precious metals like gold, platinum, or sterling silver. Depending on the design, the tactile elements can be either raised metal portions or set with diamonds. The month and day are represented by the appropriate number of elements, which are arranged on the jewelry in various configurations.

As per its further embodiments, the tactile elements (diamonds or dots) can be arranged in several different ways, depending on the type of jewelry and the customer's preferences. For example, on a ring, the diamonds or dots may be spaced evenly around the band, offering a continuous tactile experience. On earrings, one earring might encode the month, and the other could encode the day. The flexibility in the placement of elements ensures that the jewelry remains visually appealing while maintaining its personal significance.

As per its further embodiments, wearing a piece of jewelry that incorporates the TouchDate Technique offers more than just an aesthetic experience. Each time the wearer touches the tactile elements, they are reminded of their important date, evoking an emotional response tied to the specific memory. This tactile interaction transforms the jewelry into a memory tool, helping the wearer stay connected to their milestone on a physical level. The jewelry can be worn daily, serving as both a functional and symbolic reminder.

As per its further embodiments, the Technique introduces several essential features that make it distinct from other jewelry on the market. First, it employs tactile date encoding, using diamonds or dots to represent a specific month and day. Second, it offers a method of personalization where the customer chooses a date, and the elements are arranged to reflect the numbers in that date. Third, the technique maintains a discrete personal meaning, with the encoded date hidden from plain view but understood through touch. Lastly, it is adaptable across various jewelry types, providing broad versatility.

As per its further embodiments, the technique is not just about appearance; it is fundamentally about functionality. The diamonds or dots are not placed randomly or merely for decorative purposes. Instead, they serve a practical function—to encode and symbolize a specific date. This functional concept differentiates the TouchDate Technique from more traditional jewelry styles, as it allows the jewelry to have a personal, emotional purpose tied to the wearer's significant life events.

As per its further embodiments, the technique stands apart from other jewelry systems like diamond eternity rings or Braille. Diamond eternity rings may feature a set number of diamonds, but they lack any personal meaning behind the arrangement of stones. In contrast, the TouchDate Technique uses the exact number of diamonds or dots to represent a specific date, providing a symbolic and emotional connection. Similarly, while Braille uses raised dots to represent letters for reading purposes, the TouchDate Technique encodes numerical dates for personal memory representation. This focus on tactile memory and discrete personalization makes the TouchDate Technique a unique and valuable innovation in the field of personalized jewelry.

TouchDate distinguishes itself from braille jewelry by focusing on personal memory and emotional connection rather than functional text reading. While braille is designed to communicate information through raised dots for practical use, TouchDate uses tactile elements like diamonds or raised metal dots to represent significant dates, creating a symbolic and sensory link to cherished moments. Instead of conveying text, it allows the wearer to physically feel their memories, making it a deeply personal way to mark important milestones.

This innovation offers a discreet form of personalization, where the number of diamonds or dots corresponds to a specific date, yet remains unrecognizable to others. Unlike visible engravings or birthstones, TouchDate's tactile elements are a subtle, intimate reminder that holds meaning only for the wearer. This creates a sense of privacy and emotional depth, turning the jewelry into a hidden connection to personal milestones.

By physically feeling the raised elements, the wearer can relive their special moments through touch, offering a sensory connection to their memories. This adds an interactive and emotional layer to the jewelry, transforming it into more than just a visual piece. The versatility of the TouchDate technique allows it to be applied to a variety of jewelry types, offering a unique way to carry personal memories across different styles.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method of representing a specific date on a jewelry piece, comprising:
providing tactile elements in the form of diamonds, raised metal dots, or gemstones;
arranging said tactile elements such that the number of elements corresponds to the month and day of the chosen date;
wherein the tactile elements enable a sensory interaction by the wearer, providing a physical connection to the encoded date.
2. The method of claim 1, wherein the tactile elements are configured in a specific geometric pattern, such as a circle, linear arrangement, or spiral, depending on the design of the jewelry piece.
3. The method of claim 1, wherein the tactile elements are constructed from precious metals, including gold, platinum, or sterling silver, and set with gemstones, including diamonds, sapphires, or rubies.
4. The method of claim 1, wherein the tactile elements are placed in a pattern raised above the jewelry's surface to allow easy tactile recognition by the wearer.
5. The method of claim 1, wherein the tactile elements are incorporated into both visible and non-visible areas of the jewelry, such as the inner band of a ring, allows the wearer to feel the elements without them being easily noticed by others.
6. The method of claim 1, wherein the tactile elements are arranged to encode dates in formats other than month and day, such as month, day, and year, or specific time durations like hours and minutes.
7. The method of claim 1, wherein non-tactile elements, including flat, recessed, or purely visual designs, are arranged systematically to represent a significant date, enabling a visual connection to the encoded date without requiring physical interaction.

2. A personalized jewelry item, comprising:
tactile elements in the form of diamonds, raised metal dots, or gemstones;
said elements being arranged in a configuration to represent a specific date,
wherein the number of elements corresponds to the month and day of the date;
the tactile elements'arrangement does not visually reveal the encoded date to an external observer, providing a discreet, personal meaning to the wearer.
8. The personalized jewelry item of claim 2, wherein the tactile elements are designed to appear as part of a decorative pattern or motif, disguising their function as date representations.
9. The personalized jewelry item of claim 2, wherein the jewelry includes multiple layers, where the tactile elements are placed on a concealed layer of the jewelry, accessible only to the wearer.
10. The personalized jewelry item of claim 2, wherein the tactile elements are engraved or inset into the jewelry surface, making them less visible but still noticeable through touch.
11. The personalized jewelry item of claim 2, wherein the arrangement of the tactile elements is custom-designed to the wearer's specification, allowing them to choose the configuration and placement of the elements for added discretion.
12. The personalized jewelry item of claim 2, wherein the tactile elements represent multiple dates, with different sets of elements encoding multiple important milestones (e.g., birthdate and anniversary).

3. A method of applying tactile date encoding in jewelry, comprising:
utilizing diamonds, raised metal dots, or gemstones to represent a significant date by encoding the month and day;
adapting said tactile elements across various types of jewelry, including rings, necklaces, earrings, bracelets, or pendants;
wherein the tactile elements are incorporated without compromising the aesthetic design or functionality of the jewelry piece.
13. The method of claim 3, wherein the tactile date encoding is adapted for earrings, with one earring encoding the month and the other encoding the day of the chosen date.
14. The method of claim 3, wherein the tactile elements are adapted for use on a ring, with the elements spaced evenly around the band or clustered in a specific section of the band for ease of tactile recognition.
15. The method of claim 3, wherein the tactile date encoding is used in necklaces or pendants, where the elements are placed in a radial or linear arrangement around the pendant, representing the date.
16. The method of claim 3, wherein the tactile elements are applied to bracelets, with the elements distributed along the band, allows the wearer to run their fingers over them as a reminder of the chosen date.
17. The method of claim 3, wherein the tactile elements are incorporated into charm bracelets, with each charm representing a different part of the date (e.g., one charm for the month, one for the day).
18. The method of claim 3, wherein the interactive experience of the jewelry allows the wearer to engage with the encoded date through either touch or visual recognition, creating a constant emotional connection to the significant date.
19. The personalized jewelry item of claim 3, wherein the tactile engagement with the raised elements allows the wearer to form an intimate and personal connection and emotions to the commemorative date, enhancing the emotional significance each time the jewelry is touched or worn.
20. The personalized jewelry item of claim 3, wherein the raised tactile elements provide a layer of privacy and subtlety, and are composed of are composed of materials such as diamonds or other gemstones, such that the meaning of the jewelry is known only to the wearer, offering a personal experience without the need for outward disclosure.
